(19) United States
(12) Patent Application Publication
(10) Pub. No.: US 2014/0304293 A1
(43) Pub. Date: Oct. 9, 2014

(54) Apparatus and Method for Query Based Replication of Database

(71) Applicant: MARKLOGIC CORPORATION, San Carlos, CA (US)

(72) Inventors: Clark D. Richey, JR., Westminster, MD (US); Christopher Biow, Reston, VA (US); Frank E. Snow, Edmonds, WA (US)

(73) Assignee: MarkLogic Corporation, San Carlos, CA (US)

(21) Appl. No.: 13/856,870

(22) Filed: Apr. 4, 2013

(51) Int. Cl. G06F 17/30

(52) U.S. Cl. CPC G06F 17/30575
USPC 707/769

(57) ABSTRACT

A method includes applying, from a field device, a replication query to a master database on a server. Database records relevant to the replication query are received from the master database. A new query is executed against the database segment at the field device. The database segment is a subset of the master database that contains content responsive to the new query.

### FIELD OF THE INVENTION

This invention relates generally to database replication in networked environments. More particularly, this invention relates to query based replication of a database.

### BACKGROUND OF THE INVENTION

The invention is applicable to any type of database, but for the purpose of illustration, it is disclosed in the context of a document-oriented database. A document-oriented database stores semi-structured data. In contrast to well-known relational databases with “relations” or “tables”, a document-oriented database is designed around the abstract notion of a document. While relational databases utilize Structured Query Language (SQL) to extract information, document-oriented databases do not rely upon SQL and therefore are sometimes referred to as NoSQL databases.

Document-oriented database implementations differ, but they all assume that documents encapsulate and encode data in some standard formats or encodings. Encodings in use include eXtensible Markup Language (XML), Yet Another Markup Language (YAML), Javascript Object Notation (JSON), Binary JSON (BSON), Portable Document Format (PDF) and Microsoft® Office® documents. Documents inside a document-oriented database are similar to records or rows in relational databases, but they are less rigid. That is, they are not required to adhere to a standard schema.

In a document-oriented database, documents are addressed via a unique key that represents the document or a portion of the document. The key may be a simple string. In some cases, the string is a Uniform Resource Identifier (URI) or path. Typically, the database retains an index on the key for fast document retrieval.

Many users, particularly in the intelligence community, need to be able to operate (search, analyze, update, insert) on data in the field in a situation where they will only have intermittent connectivity to a centralized data server. Often the field equipment will be a laptop but it could be a server or small cluster of servers. These users may utilize advanced queries (e.g., combinations of geospatial bounding criteria, full text and Boolean logic) to load relevant data onto their field system from the centralized data server prior to deployment. Once in the field, these systems need to be automatically updated if new information becomes available on the centralized data server. Additionally, new information entered on the field systems needs to be pushed back to the central data server. Both of these operations need to happen automatically when communications to the centralized data server is available. When that communication is not available, users still need to be able to operate on their local data.

In view of the foregoing, it would be desirable to provide techniques for efficiently replicating data in a field device that only has intermittent access to a master server.

### SUMMARY OF THE INVENTION

A method includes applying, from a field device, a replication query to a master database on a server. Database records relevant to the replication query are received from the master database. A new query is executed against the database segment at the field device. The database segment is a subset of the master database that contains content responsive to the new query.

A non-transitory computer readable storage medium includes instructions executed by a processor to apply a replication query to a remote master database. Database records relevant to the replication query are received from the remote master database. A new query is executed against a database segment that is a subset of the master database that contains content responsive to the new query.

### BRIEF DESCRIPTION OF THE FIGURES

The invention is more fully appreciated in connection with the following detailed description taken in conjunction with the accompanying drawings, in which:

FIG. 1 illustrates a computer that may be utilized in accordance with an embodiment of the invention.

FIG. 2 illustrates components used to construct a document-oriented database.

FIG. 3 illustrates processing operations to construct a document-oriented database.

FIG. 4 illustrates a markup language document that may be processed in accordance with an embodiment of the invention.

FIG. 5 illustrates a top-down tree characterizing the markup language document of FIG. 4.

FIG. 6 illustrates an exemplary index that may be formed to characterize the document of FIG. 4.

FIG. 7 illustrates a system configured in accordance with an embodiment of the invention.

FIG. 8 illustrates processing operations associated with an embodiment of the invention.

Like reference numerals refer to corresponding parts throughout the several views of the drawings.

### DETAILED DESCRIPTION OF THE INVENTION

A semi-structured document, such as an XML document has two parts: 1) a markup document and 2) a document schema. The markup document and the schema are made up of storage units called “elements”, which can be nested to form a hierarchical structure. The following is an example of an XML markup document:

```
<citation publication_date=”01/02/2012”>
    <title>MarkLogic Query Language</title>
    <author>
        <last>Smith</last>
        <first>John</first>
    </author>
    <abstract>
```

The MarkLogic Query Language is a new book from MarkLogic Publishers that gives application programmers a thorough introduction to the MarkLogic query language.

</abstract>
</citation>

This document contains data for one “citation” element. The “citation” element has within it a “title” element, an “author” element and an “abstract” element. In turn, the “author” element has within it a “last” element (last name of the author) and a “first” element (first name of the author). Thus, an XML document comprises text organized in freely-structured outline form with tags indicating the beginning and end of each outline element. In XML, a tag is delimited with angle brackets followed by the tag's name, with the opening and closing tags distinguished by having the closing tag beginning with a forward slash after the initial angle bracket.

Elements can contain either parsed or unparsed data. Only parsed data is shown for the example document above. Unparsed data is made up of arbitrary character sequences. Parsed data is made up of characters, some of which form character data and some of which form markup. The markup encodes a description of the document's storage layout and logical structure. XML elements can have associated attributes in the form of name-value pairs, such as the publication date attribute of the “citation” element. The name-value pairs appear within the angle brackets of an XML tag, following the tag name.

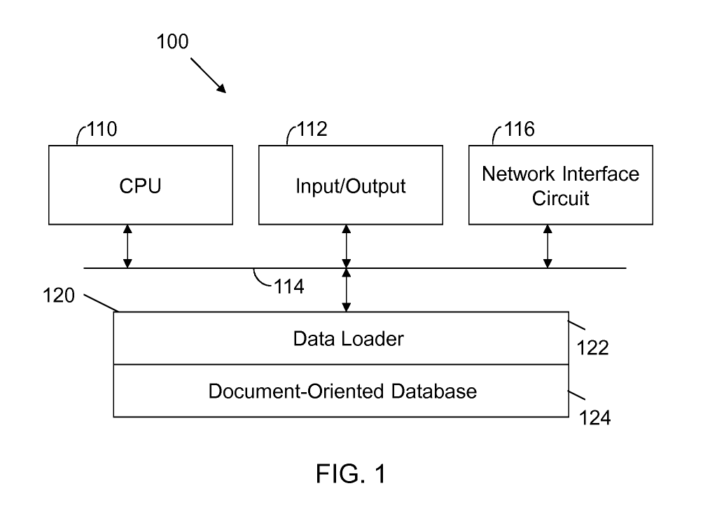

FIG. 1 illustrates a computer 100 configured in accordance with an embodiment of the invention. The computer 100 includes standard components, such as a central processing unit 110 and input/output devices 114 connected via a bus 114. The input/output devices may include a keyboard, mouse, touch screen, display and the like. A network interface circuit 116 is also connected to the bus 114. Thus, the computer 100 may operate in a networked environment.

A memory 120 is also connected to the bus 114. The memory 120 includes data and executable instructions to implement on or more operations associated with the invention. A data loader 122 includes executable instructions to process documents and form document fragments and selective pre-computed indices, as described herein. These document fragments and indices are then stored in a document-oriented database 124.

The modules in memory 120 are exemplary. These modules may be combined or be reduced into additional modules. The modules may be implemented on any number of machines in a networked environment. It is the operations of the invention that are significant, not the particular architecture by which the operations are implemented.

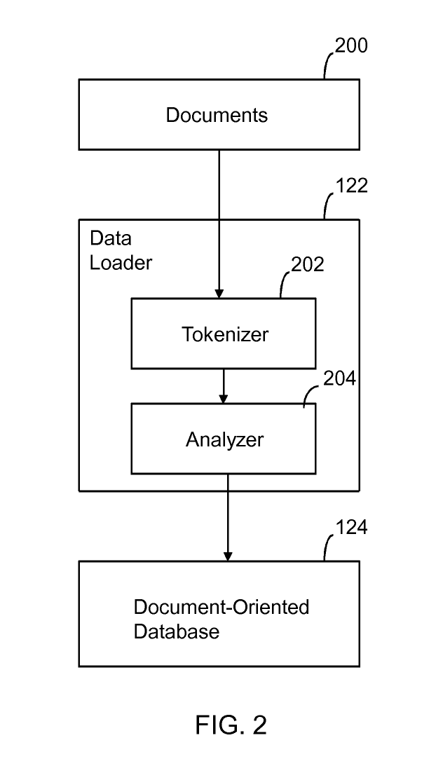

FIG. 2 illustrates interactions between components used to implement an embodiment of the invention. Documents 200 are delivered to the data loader 122. The data loader 122 may include a tokenizer 202, which includes executable instructions to produce tokens or fragments for components in each document. An analyzer 204 includes executable instructions to form document fragments with the tokens. The document fragments characterize the structure of a document. For example, in the case of a top-down tree the characterization is from a root node through a set of fanned out nodes. The document fragments may be an entire tree or portions (paths) within the tree. The analyzer also develops a set of pre-computed indices. The term pre-computed indices is used to distinguish from indices formed in response to a query. The resultant document fragments and pre-computed indices are separately searchable entities, which are loaded into a document-oriented database 124. The document fragments support queries. The pre-computed indices also support queries. The term “records” is used to reference information in a database. Records may be document fragments, pre-computed indices, tuples in a relational database and the like.

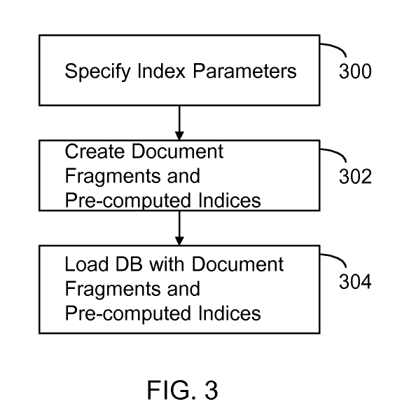

FIG. 3 illustrates processing operations associated with the components of FIG. 2. Initially, index parameters are specified. The pre-computed indices have specified path parameters. The path parameters may include element paths and attribute paths. An element is a logical document component that either begins with a start-tag and ends with a matching end-tag or consists only of an empty-element tag. The characters between the start- and end-tags, if any, are the element's content and may contain markup, including other elements, which are called child elements. An example of an element is <Greeting>Hello, world.</Greeting>.

An attribute is a markup construct comprising a name/value pair that exists within a start-tag or empty-element tag. In the following example the element img has two attributes, src and alt: <img src=“madonna.jpg” alt=‘Foligno Madonna, by Raphael’/>. Another example is <step number=“3”>Connect A to B.</step>where the name of the attribute is “number” and the value is “3”.

The next processing operation of FIG. 3 is to create document fragments and pre-computed indices 302. Finally, a database is loaded with the document fragments and pre-computed indices 304.

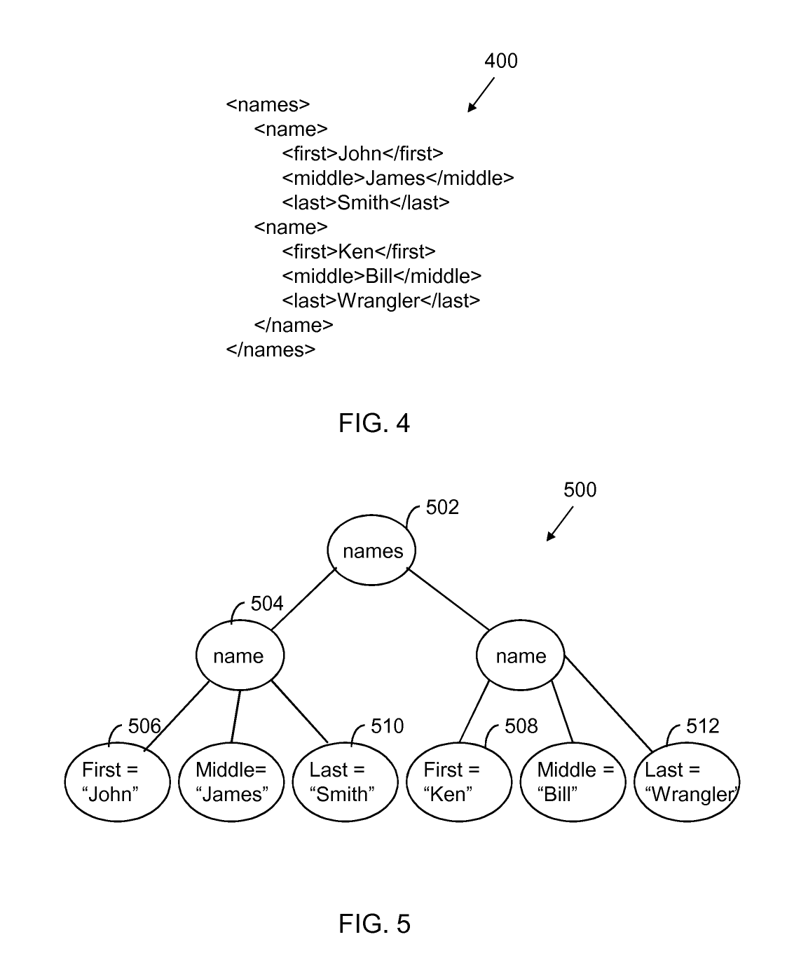

FIG. 4 illustrates a document 400 that may be processed in accordance with the operations of FIG. 3. The document 400 expresses a names structure that supports the definition of various names, including first, middle and last names. In this example, the document fragments are in the form of a tree structure characterizing this document, as shown in FIG. 5. This tree structure naturally expresses parent, child, ancestor, descendent and sibling relationships. In this example, the following relationships exist: “first” is a sibling of “last”, “first” is a child of “name”, “middle is a descendent of “names” and “names” is an ancestor of “middle”.

Various path expressions (also referred to as fragments) may be used to query the structure of FIG. 5. For example, a simple path may be defined as /names/name/first. A path with a predicate may be defined as /names/name[middle=“James”]/first. A path with a wildcard may be expressed as /*/name/first, where * represents a wildcard. A path with a descendent may be express as //first.

The indices used in accordance with embodiments of the invention provide summaries of data stored in the database. The indices are used to quickly locate information requested in a query. Typically, indices store keys (e.g., a summary of some part of data) and the location of the corresponding data. When a user queries a database for information, the system initially performs index look-ups based on keys and then accesses the data using locations specified in the index. If there is no suitable index to perform look-ups, then the database system scans the entire data set to find a match.

User queries typically have two types of patterns including point searches and range searches. In a point search a user is looking for a particular value, for example, give me last names of people with first-name=“John”. In a range search, a user is searching for a range of values, for example, give me last names of people with first-name>“John” AND first-name<“Pamela”.

The structure 500 of FIG. 5 is a tree representation of the XML document 400 of FIG. 4. A natural way of traversing trees is top-down, where one starts the traversal at the root node 502 and then visits the name node 504 followed by the first node 506. A path expression is a branch of a tree. An arbitrary branch of a tree, also referred to herein as a document fragment, may be used to form a pre-computed index.

Document trees may be traversed at various times, such as when the document gets inserted into the database and after an index look-up has identified the document for filtering. Document fragments (paths or segments) are traversed at various times: (1) when a document is inserted into a database, (2) during index resolution to identify matching indices, (3) during index look-up to identify all the values matching the user specified path range and (4) during filtering. The pre-computed indices of the invention may be utilized during these different path traversal operations.

Various pre-computed indices may be used. The indices may be named based on the type of sub-structure used to create them. Embodiments of the invention utilize pre-computed element range indices, element-attribute range indices, path range indices, field range indices and geospatial range indices, such as geospatial element indices, geospatial element-attribute range indices, geospatial element-pair indices, geospatial element-attribute-pair indices and geospatial indices.

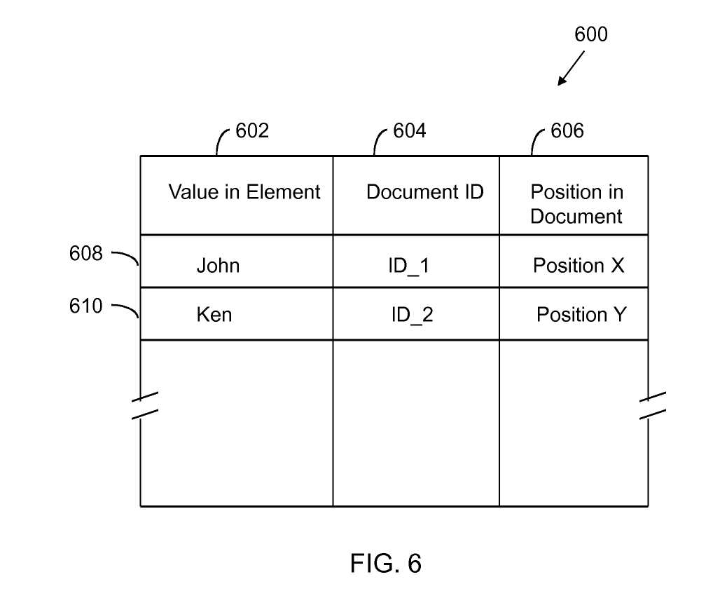

FIG. 6 illustrates an element range index 600 that may be used in accordance with an embodiment of the invention. The element range index 600 stores individual elements from the tree structured document 500. The element range index 600 includes value column 602, a document identifier column 604 and position information in the document 606. Entry “John” 608 corresponds to element 506 in FIG. 5, while entry “Ken” 610 corresponds to element 508 in FIG. 5.

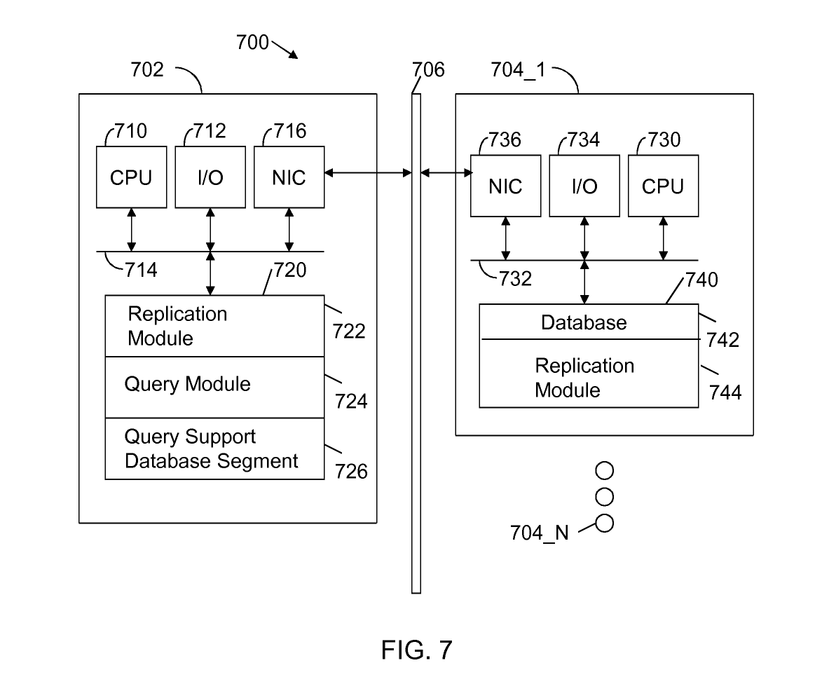

FIG. 7 illustrates a system 700 configured in accordance with an embodiment of the invention. The system includes a field device 702 and one or more servers 704_1 through 704_N connected via a network 706, which may be any wired or wireless network.

The field device 702 includes standard components, such as a central processing unit 710 connected to input/output devices 712 via a bus 714. A network interface circuit 716 is also connected to the bus 714. A memory 720 is also connected to the bus 714. The memory 720 stores a replication module 722. The replication module 722 includes executable instructions to selectively replicate content from a server 704. In particular, the replication module 722 includes executable instructions to replicate database records. A replication query is used to replicate database records. The replication query may retrieve records to support a single query or multiple queries.

The database records are then loaded into a query support database segment 726, which contains a subset of the master database. The subset of the master database contains information responsive to a query or a set of queries. A query module 724 includes executable instructions to execute a query against the query support database segment 726. The query retrieves records that were supplied by the replication query.

The replication module 722 is configured to periodically initiate sessions to access a server 704 to obtain database records. After a session is terminated, the query module 724 may be used in an offline mode to execute a query or a set of queries against the query support database segment 726. Thus, the invention supports intermittent access to servers 704 and query processing without access to servers 704.

Thus, the disclosed replication query is a query that identifies the subset of a database that needs to be replicated at a field device. This information may include records and associated binaries (e.g., pictures, videos, PDFs, etc.). The objective of the replication query is to obtain information for the field device so that the field device can be queried locally and offline. Thus, the replication query is always executed online After the relevant records are obtained by the field device, then the field device can process new queries locally and offline.

Each server 704 includes standard components, such as a central processing unit 730 and input/output devices 734 connected via a bus 732. A network interface circuit 736 is also connected to the bus 732. A memory 740 is also connected to the bus 732. The memory 740 stores executable instructions to implement operations of the invention. In one embodiment, the memory 740 stores a database 742, such as a document-oriented database.

The memory 740 also stores a replication module 744. The replication module 744 includes executable instructions to supply database records relevant to a replication query received from a field device.

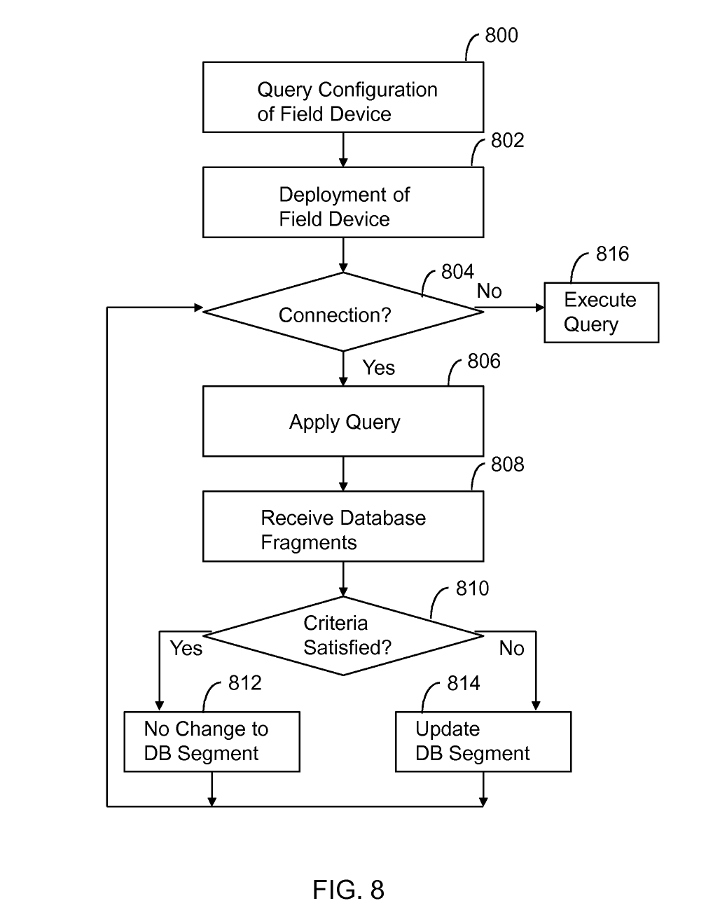

FIG. 8 illustrates processing operations associated with an embodiment of the invention. Initially, a field device is configured with data to support queries 800. In this operation, the field device (e.g., device 702) replicates information from the database 742 of server 704. The field device may replicate the entire database, but typically relies upon a replication query to obtain database records relevant to one or more queries.

The next operation of FIG. 8 is to deploy the field device 802. Deployment implies limited access to the server 704. Therefore, the field device checks to determine if a connection is available 804. If so, a replication query is applied from the field device to the server 806. The field device then receives database records responsive to the query 808.

The database records are then loaded into the query support database segment 726. A filtering operation may be used prior to such loading. For example, a check can be made to determine if specified update criteria is satisfied 810. In one embodiment, a log of replicated information is maintained. The log includes time stamps for replicated information. The specified update criteria may indicate that database fragments that have not been updated since the last log entry may be ignored. Thus, if this criteria is satisfied (810—Yes), no change to the database segment is required 812. On the other hand, if the master database has a replicated information time stamp that is subsequent to the time stamp associated with the stored information, then the database segment is updated 814.

Control then returns to block 804. When a connection is no longer available, the field device may execute a query 816. Thus, the query is applied against updated information in the query support database segment. In certain circumstances, the query may be executed while the connection still exists.

The field device 702 may push new information created locally to the server 704. The server 704 can optionally provide configurable/pluggable replication versioning rules. These rules determine how to manage things like conflicting updates of a source document.

Replication from the field device is based on saved replication queries. These replication queries can contain multi-lingual full text, geospatial, temporal and field based constraints crafted together via Boolean search operators. The geospatial constraint for the replication could be based on the location of the field device as determined by software running on the field device (e.g., GPS or IP based geolocation). The saved replication queries can be updated from the field device while it is deployed to the field. That is, the field device does not need to return to the centralized location. The replication query can also contain semantic elements for identifying records to be replicated. For example, the replication query may specify all documents that contain a person who is friends of a person in a set of target documents. Degree of separation from the target can be specified as part of the semantic query. An example query may be, “find all reports containing the word ‘London’ where the document is also contained within the geospatial coordinates . . . ” Another query may be “find all reports where ‘London’ is in the Title Section.” Another query may be “find all reports published in the last two weeks that contain a point within 50 miles of geospatial coordinates . . . ” The replication query can be automatically modified based on parameters, such as location, date and the like.

The replication from a field device to a server can be multi-tier. For example, there may be a hierarchy of computers where each has different replication criteria. Additionally, when data is pushed up the hierarchy it can be replicated back down the hierarchy (as defined by the saved queries) without first having to travel to the top of the hierarchy. That is to say that each node is able to independently replicate data based on the saved queries.

Replication can employ a security model. This security model may be based on users and groups that define who can see what information. This security model filters out records based on the security credentials of the user on whose behalf the replication is occurring.

Thus, the invention provides a Query Based Replication (QBR) capability in the form of a client side pull mechanism that frees a server from client management and replication state management. In one embodiment, the replication module 744 assists with a client's replication request. The client replication module 722 may include code to assist with creating and managing stored query criteria, retrieving replication status, and client task execution.

In one embodiment, the server does not maintain the client's queries or the client's state. In such an embodiment, the client maintains queries and query state. In another embodiment, the server maintains client replication queries and client state. In such an embodiment, the server identifies a connected state with a field device. In response to the connected state, a stored replication query associated with the field device is automatically retrieved. The stored replication query is executed against a master database to obtain database records relevant to the query. The database records are supplied to the field device.

In one embodiment, the replication module 744 at the server 704 keeps track of processed queries. In this way, the entire corpus of records associated with a query need not be transmitted. Rather, only updated records may be supplied to a field device.

In one embodiment, the client records a successful replication in the query's state document as well as the number of documents remaining for replication. In one embodiment, state information is maintained by utilizing a date time element stored in the master's documents. The stored query is appended with a date time query for the specified element. The results of the query are ordered according to the date time element to ensure that the oldest documents are replicated first. As long as there are documents left after a replication execution, the date time query is executed as a “greater than or equal to” the stored state's date time. If the number of documents left is equal to zero, the query is executed as a “greater than” only. The switch between the two equality operators ensures no documents will be replicated if no new documents have been updated on the master's database (i.e., the last uploaded documents matching the data time will match the equal in the greater than or equal to). The default query in the client code base can be overridden in the client's custom implementation.

A replication query may include associated data transmission parameters. For example, each replication query's state may be updated to include the newest date time value and the number of documents left which have not been replicated. The data transmission parameters may also include a batch size and a maximum session time.

The client utilizes stored query criteria/criterion on the client to determine which documents the master will replicate. In one embodiment, each stored criteria contains a serialized query and is saved as a document with a unique document URI based on the criteria's contents (e.g. /qbrc/criteria/92830183048). Upon each successful execution of the client task a state document is created that shares a URI part with the criteria's URI (e.g. /qbrc/criteria/92830183048/state).

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A method, comprising:
applying, from a field device, a replication query to a master database on a server;
receiving, from the master database, database records relevant to the replication query; and
executing, at the field device, a new query against a database segment that is a subset of the master database that contains content responsive to the new query.

2. The method of claim 1 further comprising determining whether the database records should be applied to the database segment.

3. The method of claim 2 wherein determining includes accessing a log of replicated information.

4. The method of claim 1 wherein the replication query includes associated data transmission parameters.

5. The method of claim 4 wherein the data transmission parameters include a batch size.

6. The method of claim 4 wherein the data transmission parameters include a maximum session time.

7. The method of claim 4 wherein the data transmission parameters include a date and time value.

8. The method of claim 4 wherein the data transmission parameters include indicia of a number of database records left to be replicated.

9. The method of claim 1 wherein the master database is a document-oriented database and the database records are document fragments.

10. The method of claim 1 further comprising uploading data to the master database from the field device.

11. The method of claim 1 further comprising filtering database records based upon security credentials.

12. The method of claim 1 further comprising maintaining queries and query state within the field device.

13. A non-transitory computer readable storage medium comprising instructions executed by a processor to:
apply a replication query to a remote master database;
receive, from the remote master database, database records relevant to the replication query; and
execute a new query against a database segment that is a subset of the master database that contains content responsive to the new query.

14. The non-transitory computer readable storage medium of claim 13 wherein the replication query includes associated data transmission parameters.

15. The non-transitory computer readable storage medium of claim 13 wherein the data transmission parameters include a batch size.

16. The non-transitory computer readable storage medium of claim 13 wherein the data transmission parameters include a maximum session time.

17. The non-transitory computer readable storage medium of claim 13 wherein the data transmission parameters include a date and time value.

18. The non-transitory computer readable storage medium of claim 13 wherein the data transmission parameters include indicia of a number of database records left to be replicated.

19. The non-transitory computer readable storage medium of claim 13 further comprising executable instructions to filter database records based upon security credentials.

20. The non-transitory computer readable storage medium of claim 13 further comprising executable instructions to maintain queries and query state outside the remote master database.

21. A non-transitory computer readable storage medium comprising instructions executed by a processor on a server to:
identify a connected state with a field device;
automatically retrieve, in response to the connected state, a stored replication query associated with the field device;
execute the stored replication query against a master database to obtain database records relevant to the replication query; and
supply the database records to the field device.

22. The non-transitory computer readable storage medium of claim 21 further comprising instructions executed by a processor on the field device to execute a new query against a database segment that is a subset of the master database.

23. The non-transitory computer readable storage medium of claim 21 further comprising instructions executed by a processor on the field device to determine whether the database records should be stored at the field device.
